(19) United States
(12) Patent Application Publication
(10) Pub. No.: US 2018/0188028 A1
(43) Pub. Date: Jul. 5, 2018

(54) SINGLE-GAP SHOCK-STOP STRUCTURE AND METHODS OF MANUFACTURE FOR MICRO-MACHINED MEMS DEVICES

(71) Applicant: PANASONIC CORPORATION, Osaka (JP)

(72) Inventors: Yaesuk Jeong, Marlborough, MA (US); Michael John Foster, Groton, MA (US); Peter Charles Philip Hrudey, Somverille, MA (US)

(21) Appl. No.: 15/333,347

(22) Filed: Oct. 25, 2016

Related U.S. Application Data
(60) Provisional application No. 62/246,364, filed on Oct. 26, 2015.

(51) Int. Cl. G01C 19/5712; G01P 15/08

(52) U.S. Cl. CPC G01C 19/5712; G01P 15/0802

(57) ABSTRACT

An inertial measurement apparatus has a movable proof mass and at least one electrode with a plurality of fingers that extend at non-right angles relative to an axis of motion of the proof mass. Multiple electrodes may be utilized with the same proof mass, with each of the electrodes having electrode fingers that extend at non-right angles relative to the axis of motion of the proof mass. A single-gap shock stop structure improves vibration immunity of micro-machined in-plane sensors. The angle of the electrode fingers creates a different effective gap to reduce the probability of contact between the proof mass and the electrode during extreme operational conditions.

### CROSS-REFERENCE TO RELATED APPLICATION

This application claims priority to U.S. Provisional Patent Application Ser. No. 62/246,364 entitled “Single-Gap Shock-Stop Structure And Methods Of Manufacture For Micro-Machined MEMS Devices,” filed Oct. 26, 2015.

### FIELD OF THE INVENTION

The disclosure relates to electrode configurations and methods for manufacturing inertial measurement devices that results in extended longevity of the manufactured product.

### BACKGROUND OF THE INVENTION

Inertial measurement devices, such as gyroscopes and accelerometers, provide high-precision sensing, however, historically, their cost, size, and power requirements have prevented their widespread use in industries such as consumer products, gaming devices, automobiles, and handheld positioning systems.

More recently, micro-electro-mechanical systems (MEMS) devices, such as gyroscopes and accelerometers, have been gaining increased attention from multiple industries because micro-machining technologies have made fabrication of miniature gyroscopes and accelerometers possible. Miniaturization enables integration of MEMS devices with readout electronics on the same die, resulting in reduced size, cost, and power consumption as well as improved resolution by reducing noise. Consumer products such as digital cameras, 3D gaming equipment, and automotive sensors are employing MEMS devices because of their numerous advantages. The demand for low cost, more sophisticated, and user-friendly devices by consumers has caused a steep rise in the demand for MEMS sensors, as they offer adequate reliability and performance at very low prices.

State-of-the-art MEMS devices, such as those disclosed in U.S. Pat. No. 7,578,189; 7,892,876; 8,173,470; 8,372,677; 8,528,404; 7,543,496; and 8,166,816, are able to sense rotational, i.e., angle or angular velocity of rotation around an axis, or translational motion, i.e., linear acceleration along an axis, around and along axes. A technique for manufacturing such devices using a process known as High Aspect Ratio Poly and Single Silicon (HARPSS) is disclosed in U.S. Pat. No. 7,023,065 entitled “Capacitive Resonators and Methods of Fabrication” by Ayazi, et al., and other publications.

A sensing apparatus, such as a MEMS accelerometer, senses applied force based on a capacitance change caused by a displacement of a suspended proof-mass with respect to a sense electrode spaced from the proof-mass across a sensing gap. However, when high acceleration is applied, for example, when free-falling where the acceleration can be >1,000 g (where g=9.8 m/sec²) the microstructure moves far more than a given gap size, making an impact with the sense electrode. Such impact may create a crack or debris at the microstructure and could also cause damage to the interfaced electronics due to the large amount of current that is flowing between the two nodes.

To protect the sensor under such extreme operational conditions, many accelerometers have physical structures, typically referred to as shock-stops or over-range stops, that prohibit further movement of a proof-mass across the complete range of the dielectric gap to prevent direct contact with the adjacent electrode. These structures have a smaller physical gap than the sensing gap, so that even under extreme acceleration, the movement of the proof-mass is limited by the gap size of the shock stop structure. As the proof-mass and the shock stop are biased at the same electrical potential, there will be no current flowing between the two nodes. Furthermore, even if debris is created, or a fracture occurs, it typically does not occur in the sensing electrode region. Therefore, any such damage may have minimum effects on sensor performance.

Such techniques, however, can only be applied to a sensor that has multiple sensing gaps. For some MEMS fabrication processes, implementing multiple sensing gaps may be associated with increased fabrication costs and production time. For example, the HARPSS process utilizes a sacrificial oxide layer to create a very narrow capacitive gap in the sub-micron range. Implementing multiple capacitive gaps in such a process requires an increased number of mask-sets to create sacrificial layers with different thicknesses.

Accordingly, a need exists for an improved manufacturing process that eliminates costly and difficult elements in the manufacturing process.

A further need exists for an improved process of manufacturing electrodes that are not susceptible to damage by movement of the proof mass under extreme operational conditions.

### SUMMARY OF THE INVENTION

Disclosed is a technique for implementation of a single-gap shock stop structure to improve vibration immunity of micro-machined in-plane sensors. To address the foregoing problems in conventional electrode designs, the angle of the electrode fingers are modified to create a different effective gap, thereby reducing the probability of contact between the proof mass and the electrode during extreme operational conditions.

According to one aspect of the disclosure, an inertial measurement apparatus has a proof mass movable along an axis of motion and a first electrode comprising at least one finger projection extending at a non-right angle θ relative to the axis of motion of the proof mass. The at least one finger projection is separated from the proof mass by a sense gap having a distance g, wherein a maximum extent of motion distance of the proof mass along the axis of motion is greater than the distance g. In one embodiment, multiple electrodes may be utilized with the same proof mass, with each of the electrodes having electrode fingers that extend at non-right angles relative to the axis of motion of the proof mass.

According to another aspect of the disclosure, an inertial measurement apparatus has a proof mass movable along an axis of motion and separated from a damping electrode by a first gap. A sensing electrode is disposed at a non-right angle relative to the axis of motion of the proof mass and separated from the proof mass by a second gap, wherein the first gap is smaller than the second gap so as to prevent the proof mass from making contact with the sensing electrode.

According to another aspect of the disclosure, an inertial measurement apparatus has a substrate and a proof mass movable relative to the substrate along an axis of motion. A first electrode comprising a plurality of parallel finger projections extending at a non-right angle θ relative to the axis of motion of the proof mass is provided and the finger projections are separated from the proof mass by a gap having a distance g. A distance d represents a maximum extent of motion of the proof mass relative to the substrate and is greater than the distance g.

The disclosed semiconductor manufacturing process enables a complex multi-layer, hermitically-sealed wafer-level packaged MEMS, such as a gyroscope or accelerometer, to be formed without the increased manufacturing costs or complexity of having multiple sensing gaps.

### BRIEF DESCRIPTION OF THE DRAWINGS

The present disclosure is illustratively shown and described in reference to the accompanying drawings in which:

FIG. 1 illustrates conceptually a cross-sectional view of a known sense electrode;

FIG. 2 illustrates conceptually a cross-sectional view of a sensor electrode with a sloped finger in accordance with the present disclosure;

FIG. 3 illustrates conceptually a diagrammatic view of the actual and effective displacement of an electrode and its corresponding effect on capacitive sensitivity in accordance with the present disclosure;

FIG. 4 illustrates conceptually a diagrammatic view of the effective and generated electrostatic force in accordance with the present disclosure;

FIG. 5 illustrates conceptually a cross-sectional view of a sensor electrode with a sloped finger and a mathematical analysis of the applied electrostatic force in accordance with the present disclosure;

FIG. 6 illustrates conceptually a diagram of a sensor with a sloped electrode in accordance with the present disclosure;

FIGS. 7A and 7B are views of the sensor electrode;

FIG. 8 is a conceptual diagram of a capacitive accelerometer sensor with multiple sloped electrodes with different angles in accordance with the present disclosure; and

FIG. 9 is a graph of a normalized traveling distance of a proof-mass with respect to the tilted angle of the electrode finger in accordance with the present disclosure.

### DETAILED DESCRIPTION

This application claims priority of U.S. Provisional Patent Application Ser. No. 62/246,364 entitled “Single-Gap Shock-Stop Structure And Methods Of Manufacture For Micro-Machined MEMS Devices,” filed Oct. 26, 2015, the entire contents of which is incorporated herein by reference for all purposes.

The present disclosure will be more completely understood through the following description, which should be read in conjunction with the drawings. The skilled artisan will readily appreciate that the methods, apparatus and systems described herein are merely exemplary and that variations can be made without departing from the spirit and scope of the disclosure.

The manufacturing techniques and designs disclosed herein may be used with any number of commercially available MEMS gyroscopes including those disclosed in the previously mentioned U.S. Pat. No. 7,023,065, and United States Patent Application Publication 2012/0227487, the subject matter of each of which is incorporated herein by reference for all purposes.

The apparatus designs and configurations disclosed herein may be manufactured with a process for making MEMS gyroscopes and accelerometers that incorporates high-aspect ratio narrow sense gaps produced by the previously referenced HARPSS process, but utilizing a new method to create a shock-stop without relying on sensing gaps having multiple different dimensions.

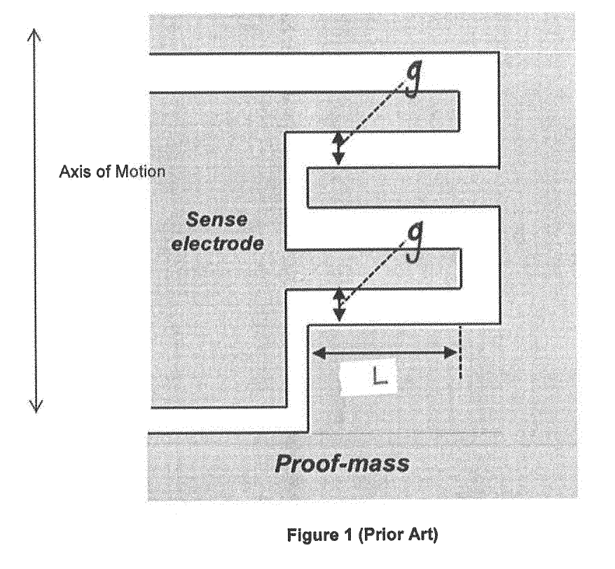

Referring to FIG. 1, a prior art sense electrode is shown in relationship to a proof mass. The sense electrode has fingers that project at a right angle relative to the axis of motion of the proof mass and overlap along a length L. Accordingly, the gap separating the sense electrode projections and the proof mass is defined by the gap distance g which can be problematic if the proof mass moves to the fullest extent along its axis of motion.

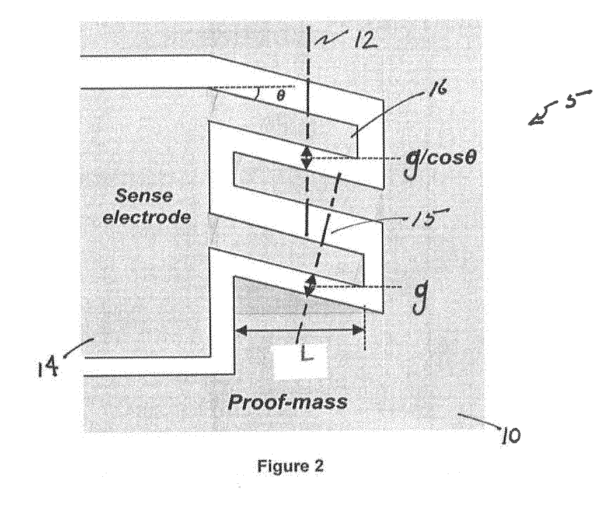

Referring to FIG. 2, a system 5 comprises a proof mass 10 that moves along an axis of motion 12 or an axis parallel thereto. The system 5 further comprises a sense electrode 14 having a plurality of finger projections 16 extending therefrom at non-right angles relative to the axis of motion 12. Rather than using a sense electrode with fingers extending normal to the axis of motion, as illustrated conceptually in the prior art of FIG. 1, the finger projections 16 are extending outward at a certain non-right angle (θ), as illustrated conceptually in FIG. 2. Assuming the distance of the HARPSS gap between the projection 16 and the proof mass 10 along an axis 15 is equal to a distance g, the effective gap distance along the axis of motion 12 between the sloped electrode 16 and the proof-mass 10 will be equal to g/cos θ which is greater than the distance g. With such a configuration, although the gap size between the proof mass and the electrode finger is equivalent to g, the effective distance the proof mass 10 must travel along axis of motion 12 will be greater, i.e., g/cosθ.

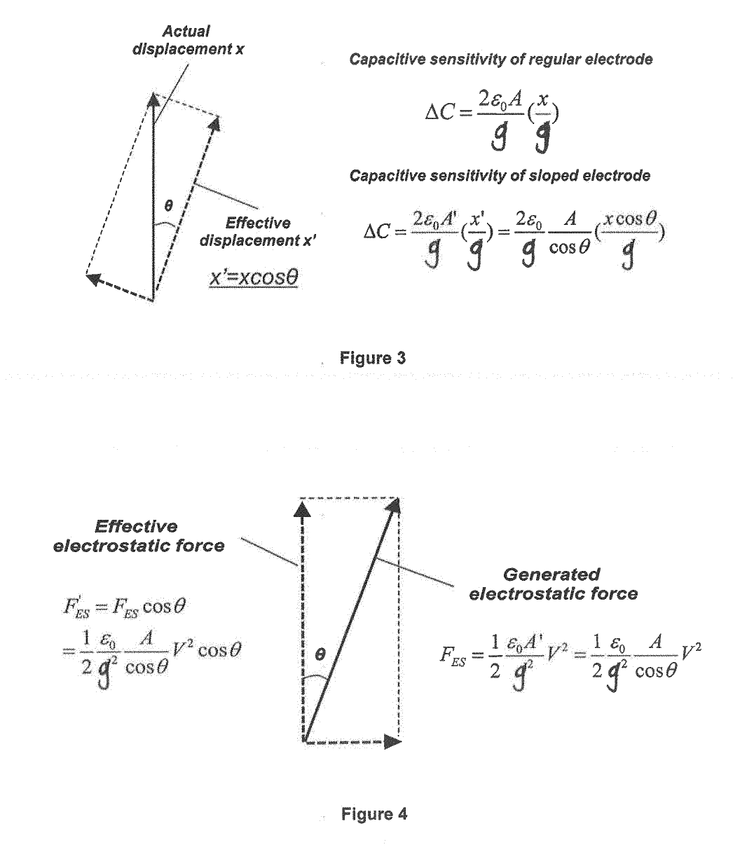

FIG. 3 illustrates the relationship between the vectors of the actual displacement x and the effective displacement x′ relative to the angle θ. Due to the sloped electrode shape, effective displacement (x′=x cos θ) is less than the actual displacement (x). However, the sloped electrode has a larger electrode area (A′=A/cos θ) compared to the regular electrode. Accordingly, the capacitive sensitivity is the same using the sloped electrode.

FIG. 4 illustrates the relationship between the vectors of effective electrostatic force and the generated electrostatic force. Due to the increased electrode area as illustrated in the figures, the larger F_{electrostatic} is induced—Affects Vₚᵤₗₗᵢₙ. Still, from vector decomposition, the effective electrostatic force will be lower than the actual electrostatic force. Accordingly, the pull-in voltage is not affected from using the sloped electrode.

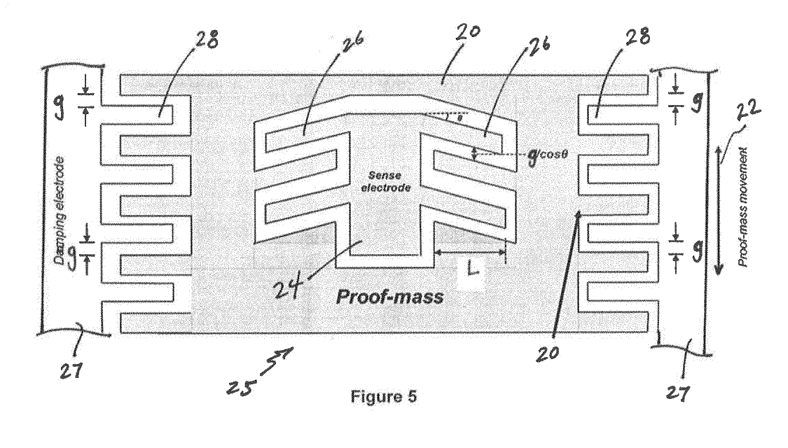

FIG. 5 illustrates an embodiment of a system 25 that comprises a proof mass 20 that moves along an axis of motion 22 or an axis parallel thereto. The system 25 further comprises a sense electrode 24 having a plurality of finger projections 26 extending therefrom at non-right angles relative to the axis of motion 22. A plurality of damping electrodes 27 with a plurality of straight fingers 28 extending toward each side of the proof mass 20, and normal to the axis of motion 22, are separated from the proof mass 20 by a distance g, as shown in FIG. 5. The sloped sense electrode 24 also has the same gap distance “g” separating it from the proof-mass 20. However, as the sensing finger is tilted by the angle θ, the travelling distance of the proof-mass 20 is equivalent to “g/cos θ,” which is a factor of 1/cos θ larger than the gap at the damping electrodes 27. Advantageously, this feature enables the use of the damping electrode fingers 28 as a shock stop. That is, under excessive movement (>g), the proof-mass 27 makes contact with the damping electrode fingers 28, but not with the sense electrode 24, thereby protecting the sense electrode 24 under this extreme acceleration. For illustrative purposes only, and not meant to be limiting, assuming θ=45°, when the damping electrode gap is 190nm, the effective sense gap would be ˜270 nm.

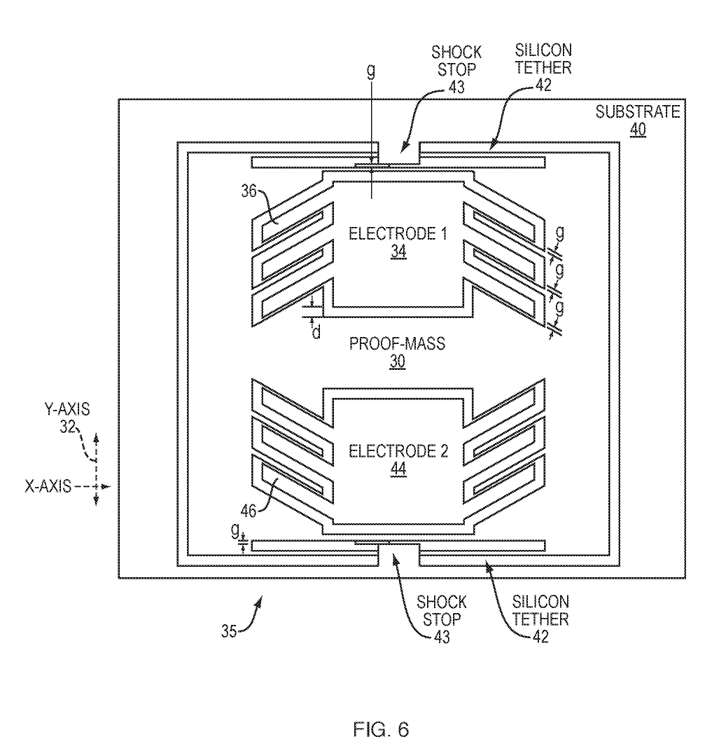

FIG. 6 illustrates conceptually a diagram of a system 35, such as an accelerometer, comprising a proof mass 30 suspended within a substrate 40 by a plurality of silicon tethers 42. Proof mass 30 moves along an axis of motion 32 or an axis parallel thereto with the extent of its travel stopped by shock stops 43 separated therefrom by a damping gap g. The system 35 further comprises a first sense electrode 34 having a plurality of finger projections 36 extending therefrom at non-right angles relative to the axis of motion 32. System 35 further comprises a second sense electrode 44 having a plurality of finger projections 46 extending therefrom at non-right angles relative to the axis of motion 32. The proof-mass 30, substrate 40, and sensing electrodes 34 and 44 are isolated with an isolating trench that separates the proof-mass 30, the substrate 40 and sensing electrodes 34, 44. Prior to fabrication, the proof-mass 30, the substrate 40 and sensing electrodes 34, 44 were originally a common silicon substrate. These structures are defined by the isolating trench “d” which is implemented using a Deep Reactive Ion-Etching (DRIE) process and which has far wider width (1˜5 μm) than the sensing gap “g.”

As illustrated, sensing gaps “g” are disposed between the proof-mass 30 and the electrodes 34 and 44. The fingers 36 of electrode 34 are slanted with an angle θ with respect to an X-axis.

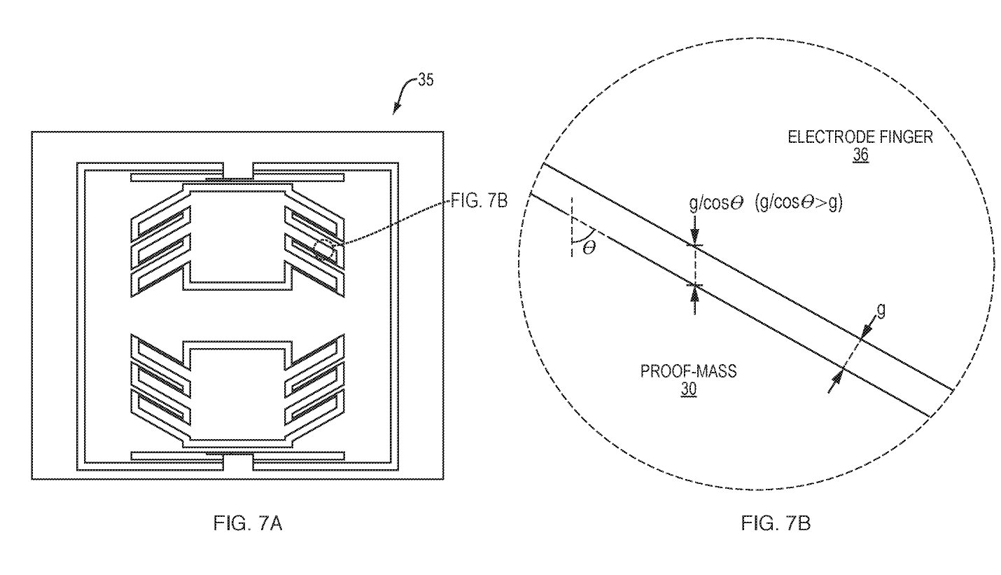

FIGS. 7A and 7B illustrate close-up views of one of the sensing fingers 36 of electrode 34 of FIG. 6 illustrating how the traveling distance of the proof-mass 30 along the axis of motion 32 (Y-axis) is longer than the actual damping gap size “g”. Although the gap size between the proof-mass 30 and the electrode finger 36 is equivalent to “g”, the effective distance that the proof-mass 30 must travel along the Y-axis would be equal to “g/cos θ”. The shock stop 43, conversely, has a minimum gap size “g” )θ=0° ) to limit further proof-mass movement under extreme acceleration. Although the proof-mass 30 may make contact with the shock stop under extreme conditions, the sense electrodes 34 and 44 do not and remain intact as the effective distance is larger.

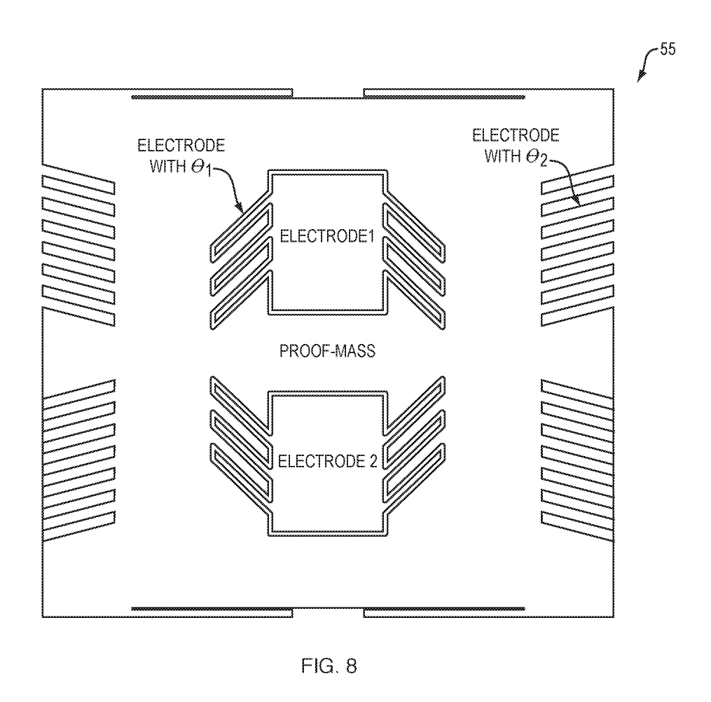

FIG. 8 is a conceptual diagram of a capacitive accelerometer sensor system 55 similar to system 35 with multiple sloped electrodes with different angles. Advantageously, the sensor system 55 facilitates low-pressure operation, where the electrodes on each side of the proof-mass increase the air-damping in order to better stabilize operation of the accelerometer.

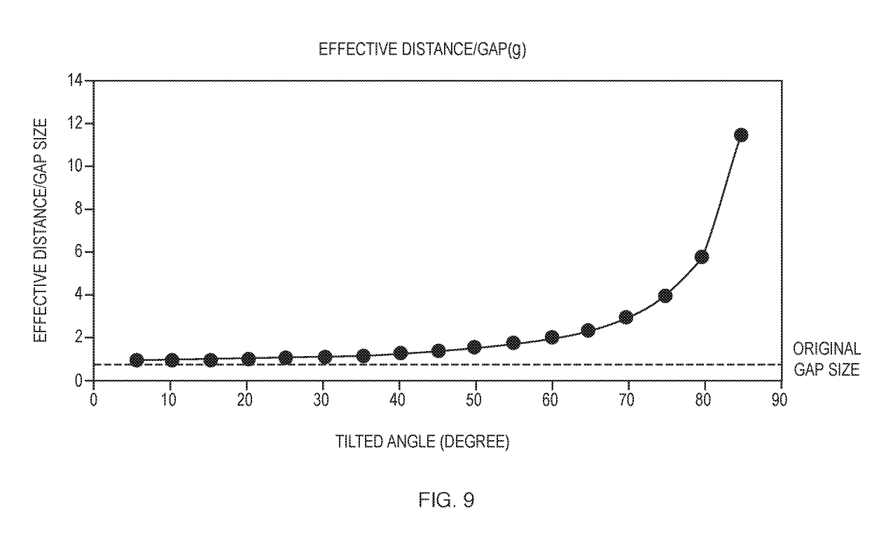

In FIGS. 2, and 5-8, as the tilted angle on the electrode finger reaches close to 90°, the effective gap size becomes much longer. Different effective gap sizes can be implemented by changing the tilted angle θ at the electrode finger. FIG. 9 is a graph of the normalized traveling distance of the proof-mass with respect to the value of the tilted angle of the electrode finger.

From the foregoing descriptions, the reader can appreciate that the disclosed sloped electrode enables implementation of double in-plane HARPSS gaps and shock stops for improved shock survivability in a sensor having a moving resonant mass, while other important sensor parameters, such as scale factor and pull-in voltage, remain unaffected. The disclosed sloped electrode further leads to improved stability due to increased HARPSS area.

It will be obvious to those reasonably skilled in the arts that the techniques disclosed herein may be similarly applied to the manufacture and fabrication of other semiconductor devices given the disclosure contained herein.

The present disclosure is illustratively described above in reference to the disclosed implementations. Various modifications and changes may be made by persons skilled in the art without departing from the scope of the present disclosure as defined in the appended claims.

1. An inertial measurement apparatus comprising:
a proof mass movable along an axis of motion; and
a first electrode comprising at least one finger projection extending at a non-right angle θ relative to the axis of motion of the proof mass, the at least one finger projection separated from the proof mass by a sense gap having a distance g,
wherein a maximum extent of motion distance of the proof mass along the axis of motion is greater than the distance g.

2. The apparatus of claim 1, wherein the maximum extent of motion distance =g/cos θ.

3. The apparatus of claim 1, wherein the first electrode further comprises a plurality of finger projections, each extending at a non-right angle θ relative to the axis of motion of the proof mass, each of the plurality of finger projections separated from the proof mass by a gap having a distance g.

4. The apparatus of claim 1, further comprising a substrate from which the proof mass is suspended.

5. The apparatus of claim 4, wherein the substrate is separated from the proof mass along an axis parallel to the axis of motion by a distance s which is equal to or less than the distance g.

6. The apparatus of claim 1, further comprising:
a second electrode comprising at least one finger projection extending at a non-right angle relative to the axis of motion of the proof mass, the at least one finger projection of the second electrode separated from the proof mass by a gap.

7. The apparatus of claim 6, wherein the second electrode comprises a plurality of finger projections, each extending at a non-right angle relative to the axis of motion of the proof mass, each of the plurality of finger projections of the second electrode separated from the proof mass by a gap.

8. An inertial measurement apparatus comprising:
a proof mass movable along an axis of motion;
a damping electrode separated from the proof mass by a first gap; and
a sense electrode disposed at a non-right angle relative to the axis of motion of the proof mass and separated from the proof mass by a second gap,
wherein the first gap is smaller than the second gap so as to prevent the proof mass from making contact with the sense electrode.

9. An inertial measurement apparatus comprising:
a substrate;
a proof mass movable relative to the substrate along an axis of motion; and
a first electrode comprising a plurality of parallel finger projections extending at a non-right angle θ relative to the axis of motion of the proof mass, the finger projections separated from the proof mass by a gap having a distance g,
wherein a distance d representing a maximum extent of motion of the proof mass relative to the substrate is greater than the distance g.
